(19) United States
(12) Patent Application Publication
(10) Pub. No.: US 2026/0050461 A1
(43) Pub. Date: Feb. 19, 2026

(54) Conference System with a Touch Controller

(71) Applicant: IADEA CORPORATION, Taipei City (TW)

(72) Inventors: Chia-Chin Wang, Taipei City (TW); Yung-Chieh Lin, Taipei City (TW)

(73) Assignee: IADEA CORPORATION, Taipei City (TW)

(21) Appl. No.: 18/805,559

(22) Filed: Aug. 15, 2024

(51) Int. Cl. G06F 9/455; G06F 3/04886; G06F 13/38; G06F 13/42; H04L 9/40

(52) U.S. Cl. CPC G06F 9/45558; G06F 3/04886; G06F 13/382; G06F 13/4282; H04L 63/0428; G06F 2009/45579; G06F 2213/0042

(57) ABSTRACT

A conference system includes a host computer and a touch controller. The host computer is used to display conference information using a conference software. The touch controller is linked to the host computer through an encrypted communication channel, and used to generate the conference information using touch buttons on the touch controller.

### BACKGROUND OF THE INVENTION

### 1. Field of the Invention

The present invention is related to a conference system, in particularly, a conference system with a touch controller.

### 2. Description of the Prior Art

Early 2000s was the first time conferencing technology became widely available and free for all the internet users thanks to services such as Skype and iChat. Furthermore, 2005 is known to be the first year of HD video conferencing. The latest and probably one of the greatest achievements of developers of conferencing technologies was the cloud system. The 2020s (owing much of its thrust to Covid-19) witnessed a ‘boom’ in the market of free video conferencing tools and platforms. Developers, major and minor companies as well as start-ups, dedicated a huge chunk of their energy to devise the latest and most comprehensive of the conferencing systems in order to serve the necessities and interests of all relevant users. Moreover, companies like Webex and Zoom started to add new features to their products and services.

The technology of video conferencing and the video conferencing platforms gains such popularity and commonality. Moreover, with the variety of customizable and secure video conferencing platforms, it is now possible for people working in various industries, companies and businesses to meet their needs for virtual communication in all forms. However, the conference software is either software-based (runs controller app) or hardware-based (external touch screen to host). Different conference systems require different touch controller devices.

### SUMMARY OF THE INVENTION

An embodiment provides a conference system. The conference system includes a host computer and a touch controller. The host computer is used to display conference information using a conference software. The touch controller is linked to the host computer through an encrypted communication channel, and used to generate the conference information using touch buttons on the touch controller.

Another embodiment provides a conference method for a conference system. The conference method for the conference system includes displaying conference information through a conference software in a host computer, and controlling the conference information using touch buttons in the touch controller linked to the host computer through encrypted communication channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a conference system according to an embodiment of the present invention.

FIG. 2 is a method for the conference system in FIG. 1 according to an embodiment of the present invention.

### DETAILED DESCRIPTION

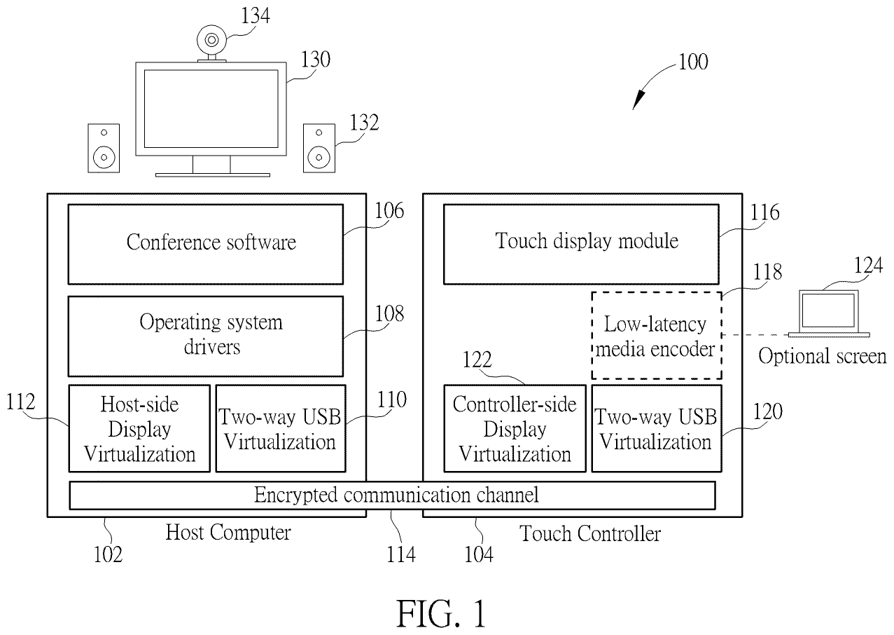

FIG. 1 is a conference system 100 according to an embodiment of the present invention. The conference system 100 includes a host computer 102 and a touch controller 104. The host computer 102 is used to display conference information using a conference software 106. The conference software 106 can be Microsoft Teams Rooms or Zoom Rooms or another software. The touch controller 104 is linked to the host computer 102 through an encrypted communication channel 114, and used to generate the conference information using touch buttons on the touch controller 104.

The host computer 102 includes the conference software 106, operating system drivers 108, a two-way universal serial bus (USB) virtualization 110, and a host-side display virtualization 112. The conference software 106 communicates with the hardware on the host computer 102 using the operating system drivers 108. The operating system drivers 108 control the display 130, the speaker 132, the webcam 134 the USB devices, and the touch controller 104 to be used in the conference software 106.

The encrypted communication channel 114 can be Ethernet or Wi-Fi. Therefore, the distance between the host computer 102 and the touch controller 104 can be more than 20 meters. The host computer 102 simulates USB channel using the two-way USB virtualization 110. The two-way USB virtualization 110 simulates the touch controller 104 as a USB device and simulates the encrypted communication channel 114 as a USB channel. In prior art, the conference software 106 communicates with the touch controller 104 with a USB channel and the distance between the host computer 102 and the touch controller 104 should be below 5 meters due to the limitation of the USB cable. However, the embodiment of the present invention links the host computer 102 and the touch controller 104 using the encrypted communication channel 114 (Ethernet or Wi-Fi), thus the distance between the host computer 102 and the touch controller 104 can be more than 20 meters. The conference software 106 uses the two-way USB virtualization 110 to simulate the touch controller 104 as a USB device, thus there is no need to modify the conference software such as Microsoft Teams Rooms or Zoom Rooms.

The host computer 102 uses the host-side display virtualization 112 to simulate a virtual display device for conference software such as Microsoft Teams Rooms or Zoom Rooms on which to display a control interface. The content drawn on the virtual display device is captured and sent to controller-side display virtualization 122 in touch controller 100 to be shown to the user for meeting control.

The touch controller 104 includes a touch display module 116, a low-latency media encoder 118, a two-way USB virtualization 120, and a controller-side display virtualization 122. The touch display module 116 is used to control the display and the touch buttons on the user interface of the touch controller 104. The touch controller 104 may be a tablet, a meeting touch console, or another touch device. The touch display module 116 can input the touch signal from the users and display the touch buttons on a touch screen of the touch controller 104 as received by the controller-side display virtualization 122 from host-side display virtualization 112.

The touch controller 104 is linked to the host computer 102 through the encrypted communication channel 114. The encrypted communication channel 114 can be Ethernet or Wi-Fi. The touch controller 104 can simulate a USB channel as the encrypted communication channel 114 using the two-way USB virtualization 120. The simulation of the USB channel makes the touch controller 104 a simulated USB device, thus there is no need to modify the conference software such as Microsoft Teams Rooms or Zoom Rooms.

The user may bring an external device 124 (such as a notebook or a smartphone) to display presentation content for sharing, such as PowerPoint slides or multimedia files, using a high definition multimedia interface (HDMI) cable or a USB type-C cable. The external device 124 can be connected to the touch controller 104 using the HDMI cable or the USB type-C cable, and the low-latency media encoder 118 in the touch controller 104 can convert the video signal (the HDMI signal or the USB type-C signal) into the universal video class (UVC) signal. Then, the UVC signal can be transmitted to the host computer 102 through the encrypted communication channel 114 for displaying the conference information in the external device 124.

The touch controller 104 can also be used for BYOM (Bring Your Own Meeting) applications, where the user brings an external device 124 which connects to the touch controller 104 using USB cable. The two-way USB virtualization 110 in host computer 102 and two-way USB virtualization 120 in touch controller 104 work in-tandem to allow USB devices connected to host computer be simulated as USB devices attached to the external device, thereby allowing the user to run any meeting software on the external device, while taking advantage to advanced conferencing audio-visual equipment 130, 132, 134 connected to the host computer 102.

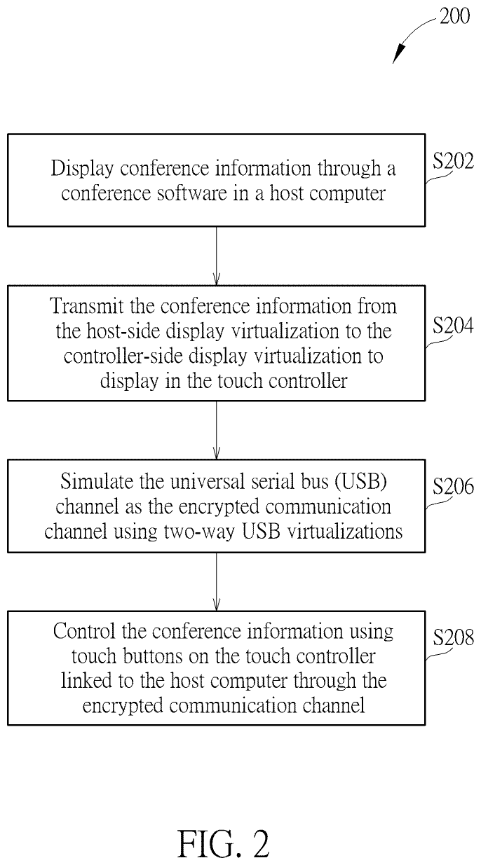

FIG. 2 is a method 200 for the conference system 100 according to an embodiment of the present invention. The method 200 includes the following steps:

Step S202: Display conference information through a conference software 106 in a host computer 102;

Step S204: Transmit the conference information from the host-side display virtualization 112 to the controller-side display virtualization 122 to display in the touch controller 104;

Step S206: Simulate the universal serial bus (USB) channel as the encrypted communication channel 114 using two-way USB virtualizations 110, 120; and

Step S208: Control the conference information using touch buttons on the touch controller 104 linked to the host computer 102 through the encrypted communication channel 114.

In step S202, the conference information is displayed on the virtual display made available through host-side display virtualization 112 of the host computer 102 using the conference software 106. In step S204, the conference information is transmitted from the host-side display virtualization 112 to the controller-side display virtualization 122 to display in the touch controller 104. In step S206, the universal serial bus (USB) channel is simulated as the encrypted communication channel 114 using two-way USB virtualizations 110, 120. In step S208, the conference information is controlled using touch buttons on the touch controller 104 linked to the host computer 102 through the encrypted communication channel 114. The users can control the conference information using the touch buttons on the touch controller 104 and display the conference information through the conference software 106 in the host computer 102.

In summary, the present invention provides a conference system 100 using the encrypted communication channel 114 to link a host computer 102 and a touch controller 104 together. The encrypted communication channel 114 may be Ethernet or Wi-Fi, thus the distance between the host computer 102 and the touch controller 104 can be more than 20 meters. The conference system 100 of the present invention is more convenient than the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A conference system comprising:
a host computer configured to display conference information using a conference software; and
a touch controller linked to the host computer through an encrypted communication channel, and configured to generate the conference information using touch buttons on the touch controller.

2. The conference system of claim 1, wherein the host computer simulates universal serial bus (USB) channel using a two-way USB virtualization.

3. The conference system of claim 1, wherein the host computer simulates a virtual display device for capturing conference control user interface using a host-side display virtualization.

4. The conference system of claim 1, wherein the touch controller simulates universal serial bus (USB) channel using a two-way USB virtualization.

5. The conference system of claim 1, wherein the touch controller displays the touch buttons using a controller-side display virtualization.

6. The conference system of claim 1, wherein the encrypted communication channel is Ethernet or Wi-Fi.

7. The conference system of claim 1, wherein the touch controller converts an external video signal into a universal video class (UVC) signal through a low-latency media encoder.

8. The conference system of claim 7, wherein the external video signal is a high definition multimedia interface (HDMI) signal or a universal serial bus type C (USB-C) signal.

9. The conference system of claim 1, wherein the touch controller is a tablet or a meeting touch console.

10. The conference system of claim 1, wherein the conference software is Microsoft Teams Rooms or Zoom Rooms.

11. A conference method for a conference system, comprising:
displaying conference information through a conference software in a host computer; and
controlling the conference information using touch buttons in the touch controller linked to the host computer through an encrypted communication channel.

12. The conference method of claim 11, further comprising simulating universal serial bus (USB) channel using a two-way USB virtualization in the host computer.

13. The conference method of claim 11, further comprising simulating a display to capture the conference control user interface using a host-side display virtualization in the host computer.

14. The conference method of claim 11, further comprising simulating universal serial bus (USB) channel using a two-way USB virtualization in the touch controller.

15. The conference method of claim 11, further comprising displaying the touch buttons using a controller-side display virtualization in the touch controller.

16. The conference method of claim 11, wherein the encrypted communication channel is Ethernet or Wi-Fi.

17. The conference method of claim 11, further comprising converting an external video signal into a universal video class (UVC) signal in the touch controller.

18. The conference method of claim 17, wherein the external video signal is a high definition multimedia interface (HDMI) signal or a universal serial bus type C (USB-C) signal.

19. The conference method of claim 11, wherein the touch controller is a tablet or a meeting touch console.

20. The conference method of claim 11, wherein the conference software is Microsoft Teams Rooms or Zoom Rooms.
